(19) United States
(12) Patent Application Publication
(10) Pub. No.: US 2023/0102292 A1
(43) Pub. Date: Mar. 30, 2023

(54) SECURE MANAGEMENT OF APPLICATION PROGRAMMING INTERFACE (API) REQUEST INFORMATION

(71) Applicant: Moesif, Inc., San Francisco, CA (US)

(72) Inventors: Derric Stephen Gilling, San Francisco, CA (US); Devendra Kumar Modium, San Francisco, CA (US); Xingheng Timothy Wang, San Francisco, CA (US)

(21) Appl. No.: 17/488,508

(22) Filed: Sep. 29, 2021

(51) Int. Cl. H04L 29/06; H04L 29/08

(52) U.S. Cl. CPC H04L 63/0435; H04L 63/104; H04L 63/20; H04L 67/1097

(57) ABSTRACT

Systems, methods, and software described herein manage and process application programming interface (API) statistics associated with an API provider. In one implementation, a secure proxy is used to obtain API request information and encrypt at least a portion of the API request information. Once encrypted the API request information is communicated to a monitoring service. The secure proxy is further configured to receive a summary request associated with usage of the API provider and encrypt at least one attribute in the request. The secure proxy also retrieves summary information from the API monitoring service using the request with the at least one encrypted attribute and generates a summary using the summary information.

### BACKGROUND

Web service application programming interfaces (APIs) are defined interfaces that permit interactions to occur between the service associated with the APIs and users of the APIs. These APIs may permit users to obtain data from the service associated with the API, post data to the service associated with the API, or provide some other data operation with relation to the service associated with the API. For example, a web service API may permit an eCommerce seller to obtain shipping information, such as cost estimates, from a shipping service provider. Thus, rather than locally importing and updating the information from the shipping service provider, the eCommerce seller may obtain the required information from one or more databases maintained by the shipping service provider.

However, although APIs may provide efficient access to data between different services, difficulties can occur in determining how the various end users interact with and use the APIs. Specifically, monitoring statistics associated with the API requests can be burdensome, especially as the number of requests increase. Moreover, maintaining security associated with the API requests while performing API usage monitoring can add further complications for an API provider.

### OVERVIEW

Provided herein are systems, methods, and software to securely manage application programming interface (API) request information. In one implementation, a proxy may receive API request information from an API provider, wherein the API request information comprises attributes identified in API requests. The proxy further encrypts at least a portion of the attributes based on an attribute type associated with each of the attributes and communicates the API request information to an API monitoring service with the portion encrypted. The proxy also receives a summary request associated with usage of the API provider, wherein the summary request indicates at least one attribute in the API request information. The proxy encrypts the at least one attribute and retrieves summary information from the API monitoring service based at least one the request with the at least one encrypted attribute and generates a summary to support the summary request using the summary information.

### BRIEF DESCRIPTION OF THE DRAWINGS

Many aspects of the disclosure can be better understood with reference to the following drawings. While several implementations are described in connection with these drawings, the disclosure is not limited to the implementations disclosed herein. On the contrary, the intent is to cover all alternatives, modifications, and equivalents.

FIG. 1 illustrates a computing environment to securely manage application programming interface (API) request information according to an implementation.

FIG. 2 illustrates a method of operating a security proxy to securely manage API request information according to an implementation.

FIG. 3 illustrates a timing diagram of storing API request information with a monitoring service according to an implementation.

FIG. 4 illustrates a timing diagram of retrieving summary information from a monitoring service according to an implementation.

FIG. 5 illustrates a data structure to store API request information at a monitoring service according to an implementation.

FIG. 6 illustrates a computing system to securely manage API request information according to an implementation.

### DETAILED DESCRIPTION

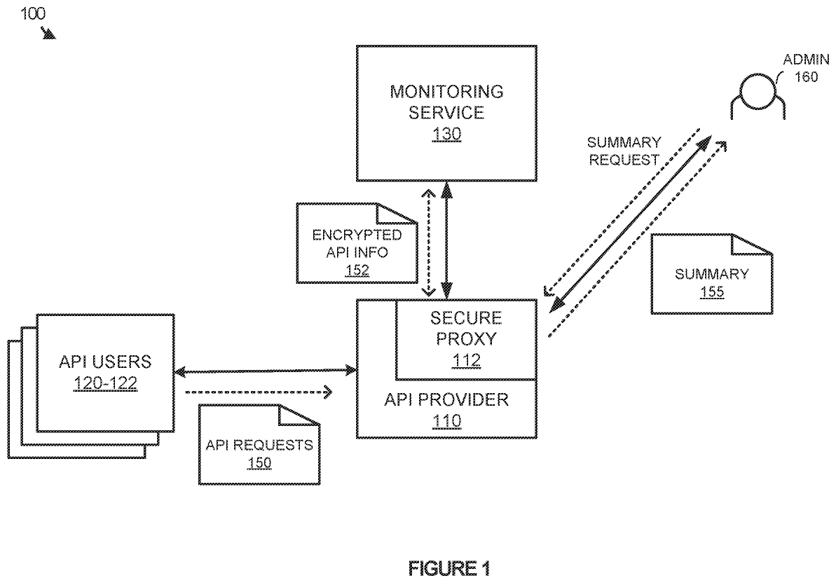

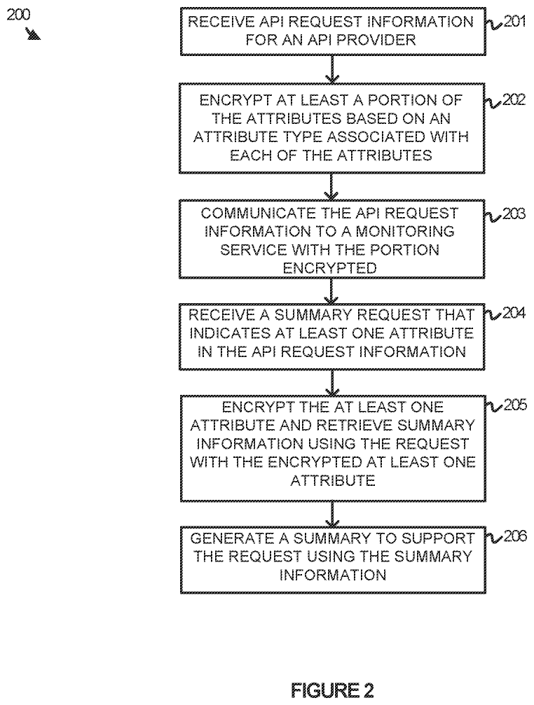

FIG. 1 illustrates a computing environment 100 to securely manage application programming interface (API) request information according to an implementation. Computing environment 100 includes API users 120-122, API provider 110, secure proxy 112, monitoring service 130, and administrator 160. Computing environment 100 further includes API requests 150, encrypted API request information 152, and summary 155. Monitoring service 130 provides operation 200 that is further described below in FIG. 2.

In operation, API users 120-122 generate API requests 150 over a network connection to API provider 110, wherein the requests may be used to provide various functionality for the API users. API requests 150 may correspond to requests to retrieve information from a service provided by API provider 110, post information to a service provided by API provider 110, modify data stored by a service provided by API provider 110, or some other operation associated with API provider 110. As an example, an API request of API requests 150 may request a social media post corresponding to a user of a social media service provided by API provider 110. API users 120-122 may correspond to individual users, service providers, such as other web services (video, social media, and the like), or some other user of a web API. API provider 110 may comprise a social media API provider, a mail service API provider, a video service API provider, or some other API provider.

As API requests 150 are obtained by API provider 110, API request information is obtained by secure proxy 112 and at least a portion of the API request information is encrypted prior to forwarding the API request information as encrypted API information 152 to monitoring service 130. This encrypted API request information 152 may include attributes identified in the header and/or payload of the API requests. The attributes for each request may include a user or source identifier associated with the API request, the API request type included in the request (e.g., get, post, etc.), a timestamp associated with the request, or some other attribute type related to the API request. In some examples, a user may define the attribute types that are encrypted prior to providing the API request information to monitoring service 130. For example, a user may define that user identifiers and API request types should be encrypted prior to forwarding the API request information to monitoring service 130. Accordingly, as the API request information is received from API provider 110, secure proxy 112 may encrypt the relevant attributes and forward the API request information with the request attributes encrypted. The one or more encryption keys used to encrypt the attributes may be maintained by secure proxy 112. In some examples, secure proxy 112 may operate in a separate data center from monitoring service 130.

As encrypted API request information 152 is received from secure proxy 112, monitoring service 130 may maintain one or more data structures that can be used to provide usage summaries associated with API provider 110. In at least one example, administrator 160 may generate a summary request that is received by secure proxy 112. The request may indicate attributes of interest, a period of interest, or some other information. For example, a user may request a summary that visually represents API request type usage as a function of time, may request a summary that visually represents API request information for one or more users as a function of time, or some other request to summarize the usage of API provider 110. In response to the request, secure proxy 112 may identify attributes in the request that are required to be encrypted before the required data can be received. For example, if a user required information about a specific user, the user identifier may be encrypted using the same encryption mechanism as used to encrypt the API request information. Once encrypted, the relevant information can be retrieved from monitoring service 130. The retrieved information may also be encrypted, requiring secure proxy 112 to decrypt at least a portion of the information prior to providing summary 155 to administrator 160. Summary 155 may comprise raw information that is distributed back to a console of the administrator that generates the display. Summary 155 may also comprise a visual representation of the data and displayed using a web browser or some other application.

FIG. 2 illustrates a method 200 of operating a security proxy to securely manage API request information according to an implementation. The steps of method 200 are referenced parenthetically in the paragraphs that follow with reference to systems and elements of computing environment 100 of FIG. 1. Method 200 may be performed by secure proxy 112, wherein secure proxy may comprise a container, a virtual machine, or physical machine. Secure proxy 112 may be in a first data center, while monitoring service 130 may in a second data center.

As depicted, method 200 includes receiving (201) receiving application programming interface (API) request information from an API provider, wherein the API request information comprises attributes identified for API requests. The attributes may include header attributes, payload attributes, time stamp attributes, or some other attribute associated with the API requests. The header attributes may include user identifier information for the request, the API request type, or some other information identified from the request. As the API information is received, method 200 further includes encrypting (202) at least a portion of the attributes based on an attribute type associated with each of the attributes and communicating (203) the API request information to an API monitoring service with the portion encrypted. In some implementations, an administrator associated with API provider 110 may indicate one or more attribute types to be encrypted. For example, API provider may indicate that user identifier information should be encrypted. Accordingly, when an attribute is received that corresponds to a user identifier, the attribute is encrypted using one or more encryption keys maintained by secure proxy 112. Once the attributes are encrypted, the attributes are provided to monitoring service 130. In some examples, monitoring service 130 may store the attributes in one or more data structures, which can be searched to respond to queries. In some examples, monitoring service 130 may aggregate or otherwise process a portion of the attributes to prepare the data for future queries. For example, data may be aggregates that demonstrates the rate of API queries for a particular user.

As the API request information is stored at monitoring service 130, method 200 further provides receiving (204) a summary request associated with usage of the API provider, wherein the summary request indicates at least one attribute in the API request information. For example, a request my administrator 160 may request the API request usage associated with API user 120. In response to the summary request, method 200 further includes encrypting (205) the at least one attribute and retrieving summary information from the API monitoring service based at least on the request with the at least one encrypted attribute. Referring to the previous example of a summary for API user 120. The identifier for API user 120 can be encrypted by secure proxy and used to retrieve the API request usage information associated with the encrypted API user. The API request information may include the number of requests as a function of time, the types of requests as a function of time, or some other information associated with the API usage for the API user.

Once the information is received from the monitoring service, the method further generates (206) a summary to support the summary request using the summary information. In one example, the raw summary information may be provided to the administrative computing element for displaying the summary, wherein the administrative computing element may generate the display. In other examples, secure proxy 112 may generate a display of the summary, wherein the display may include graphs, tables, timelines, or some other display of the requested summary by the administrator. In at least one implementation, secure proxy 112 may decrypt a portion of the summary information provided by monitoring service 130. For example, user identifiers in the summary information may be decrypted to provide the summary to administrator 160. Thus, while the information provided by monitoring service 130 is encrypted, a portion of the information may be decrypted by secure proxy 112 prior to forwarding the summary to administrator 160.

In some implementations, the summary provided to administrator 160 may be provided to a web browser or other application capable of displaying summary 155. In some implementations, the summary request may comprise an API request for the summary data, wherein summary 155 may comprise raw data that is capable of being integrated in a local database maintained by administrator 160, may be used to provide API billing and invoicing, or may be used to generate charts in their customer-facing applications. The API request to secure proxy 112 by the administrator or administrative system may comprise a one-time request, may comprise a periodic request, or may comprise some other interval of requests to support the required functionality. Once the raw data is provided as summary 155, a local machine or set of machines may generate the display, update the required local database, generate one or more reports, or provide some other function on the data.

In some examples, the administrator may generate a request for alerts when API request information satisfies one or more criteria. For example, an administrator may request that a summary or an alert is generated from monitoring service 130 when a user generates a set quantity of requests within a period. When the request is generated and received by secure proxy 112, secure proxy 112 may encrypt any required data associated with the alert request (e.g., name of the user) and communicate the request to monitoring service 130 with the encrypted data. Monitoring service 130 may then be configured using the encrypted data to identify the relevant event for the administrator. When the event is identified, a notification or summary of the event is communicated to secure proxy 112 that, in turn, communicates the alert to the administrator. In some examples, in communicating the alert or summary to administrator 160, a portion of the data provided in association with the alert may be decrypted and provided to the user decrypted. The alert or summary can be provided as an email, a text message, a pop-up on a webpage, or some other alert. Advantageously, an administrator may generate a summary rule using unencrypted data, and secure proxy may translate the summary rule to be applied by monitoring service 130.

In at least one example, limits can be set in the types of summary requests and rules that are generated for the data API request information maintained by monitoring service 130. For example, administrators may be limited to requesting information about unencrypted attributes, specific types of encrypted attributes, or some other limitation. For example, while one administrator associated with API provider 110 can access a first set of encrypted attributes, a second administrator may be incapable of accessing the same addressing attributes. In some implementations, the data that is distributed to a requesting administrator or administrative system may have portions of the attributes encrypted or may not be able access portions of the attributes. For example, the summary that is provided to a first administrator may include all the attributes unencrypted, while the summary that is provided to a second administrator may include a portion of the attributes encrypted or unavailable. Examples of the data that is encrypted may include user identifiers, payload information, the types of requests, or some other information. This information may not be relevant to the requesting administrator, or the requesting administrator may not have permissions to access the information. When a request is provided to the secure proxy, the secure proxy may identify the permissions associated with administrator making the request and determine how to execute the request. Secure proxy 112 may be used to permit the request, block the request, encrypt/decrypt attributes associated with the requesting administrator, or provide some other similar operation.

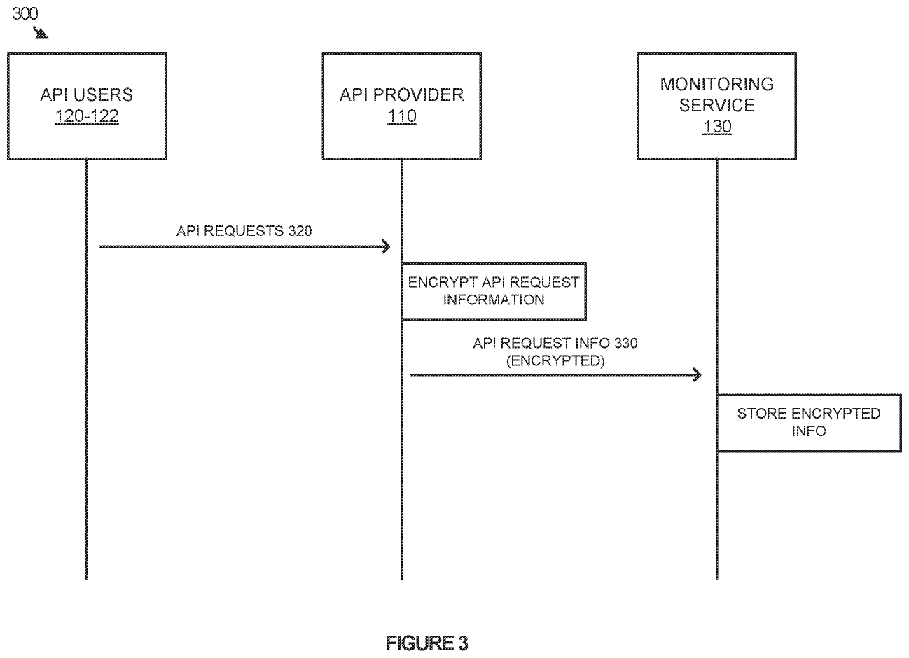

FIG. 3 illustrates a timing diagram 300 of storing API request information with a monitoring service according to an implementation. Timing diagram 300 includes API users 120-122, API provider 110 with secure proxy 112, and monitoring service 130 from computing environment 100 of FIG. 1. Timing diagraph 300 further includes API requests 320 and API request information 330

In timing diagraph 300 API users 120-122 generate API requests 320 that are received by API provider 110. The API requests may be used to obtain information, post information, change information in a database, or some other API requests. API users 120-122 may represent individual users, companies, organizations, or some other user. For example, a first website may use API provider 110 to retrieve information for the website. As the information is obtained, API provider 110 may provide the information to secure proxy 112 that encrypts at least a portion of the attributes in the API request information. In some examples, the encrypted portion corresponds to vulnerable data that can correspond to user identifiers, API request types, payload, or some other information from the API requests. Once encrypted, the API request information 330 is provided to monitoring service 130, wherein monitoring service 130 may store the data in one or more data structures. In some examples, monitoring service 130 may process the API request information to determine one or more statistics associated with the API request information. The processing may include a quantity of API requests associated with one or more API users, the number of requests associated with an API request type, or some other processing of the API request information. The processing may occur prior to a summary request, may occur in response to a summary request, or may occur at some other interval.

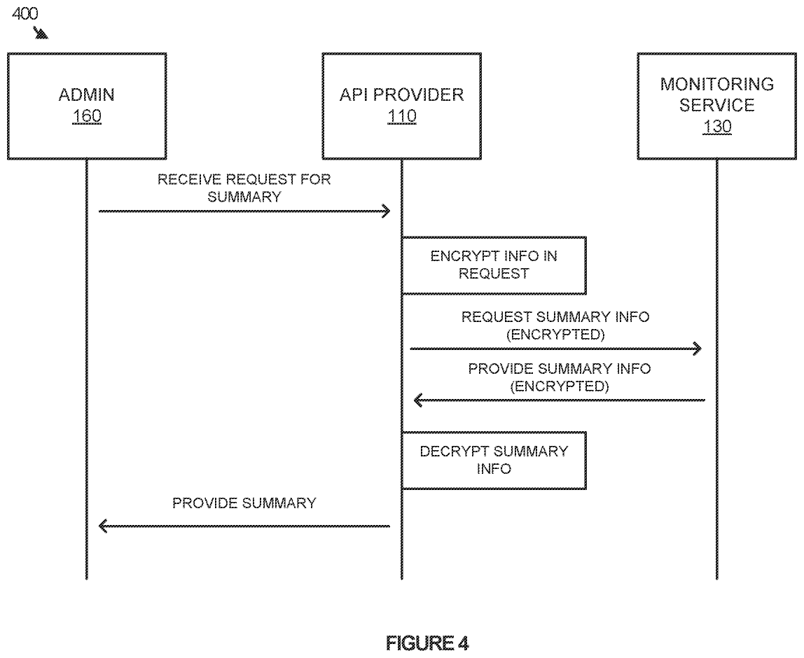

FIG. 4 illustrates a timing diagram 400 of retrieving summary information from a monitoring service according to an implementation. Timing diagram 400 includes administrator 160, API provider 110 with secure proxy 112, and monitoring service 130. The steps of timing diagram 400 may occur after the steps described above with respect to timing diagram 300 of FIG. 3.

In timing diagram 400, administrator 160 generates a summary request that is received by secure proxy 112 for API provider 110. In response to receiving the summary request, secure proxy 112 may encrypt at least a portion of the attributes included in the request to retrieve the required summary information from monitoring service 130. For example, a request may indicate a user identifier for API request information associated with the user identifier. If the user identifier is encrypted when the API request information is communicated to monitoring service 130, the user identifier may be encrypted by secure proxy 112 to identify relevant information in monitoring service 130. Once portions of the summary request are encrypted, secure proxy 112 may request and receive summary information from monitoring service 130.

In some examples, at least a portion of the summary information may be encrypted. For example, the summary information may provide encrypted identifiers associated with one or more users. When received, secure proxy 112 may decrypt the identifiers and provide the decrypted information to administrator 160. In some examples, the summary provided may include the raw summary information, permitting the administrative computing console to generate a display of the summary information. In other implementations, a visual summary may be generated by the secure proxy using the summary information provided by monitoring service 130. The visual representation may include graphs, tables, or some other visual reference of the requested summary information. For example, a graph may be used to demonstrate the usage of the API provider by one or more API users as a function of time.

In some implementations the encryption keys that are used by API provider 110 and secure proxy 112 are rotated using a keystore, such as Amazon Web Services (AWS) Key Management Service (KMS). This keystore may change the key that is used to encrypt the data periodically, such as daily, weekly, monthly, or some other interval. Because the keys are rotated, the correct key must be selected to decrypt the data from monitoring service 130. To provide this functionality, secure proxy 112 may select one or more keys to decrypt the data based on the date range or time range selected for the summary data. Thus, from a key store, secure proxy 112 may identify the corresponding key or keys for the range and apply the keys to the encrypted data to provide the summary. In some examples, as time stamps could differ based on clock timings of the computing systems or a cluster of computing systems providing the secure proxies, a checksum may be performed in association with the key to determine whether the key applies to the requested data. For example, secure proxy 112 may estimate the key to be used in association with the data based on time stamps in the summary request. When the key is applied retrieved, a checksum can be calculated for the key to determine whether the key is appropriate for the data. If incorrect, secure proxy 112 may use a key for a previous period or a subsequent period and perform the same process until a proper key is determined for the requested data.

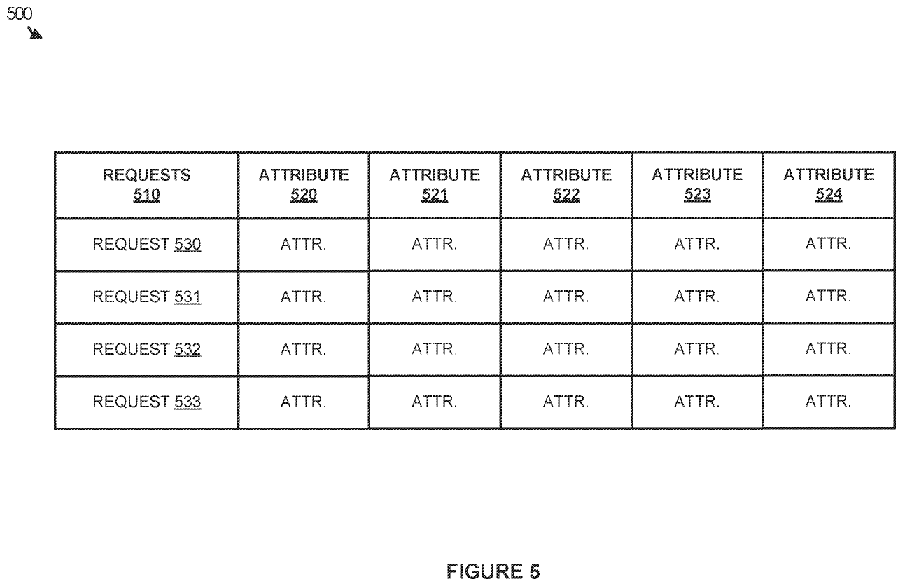

FIG. 5 illustrates a data structure 500 to store API request information at a monitoring service according to an implementation. Data structure 500 includes requests 510 (requests 530-533) and attributes 520-524.

As described herein, a secure proxy may be used to encrypt at least a portion of the API request information provided from an API provider. The API request information may include attributes that correspond to header information for the requests, payload information for the requests, time stamps for the requests, or some other attribute for the request. Here, the API request information includes five different attributes (types of attributes) per request. Once API information is received by the secure proxy, the secure proxy may encrypt attributes 522-523 using one or more encryption keys maintained by the proxy service. After encryption, the API request information is provided to the monitoring service where the data is stored in one or more data structures. The data may then be retrieved and processed to respond to summary requests for an administrator associated with the API provider. In some examples, the processing of the data may use the encrypted versions of the attributes. For example, the number of API requests from a particular API user may be associated with the encrypted identifier for the user. Once the information is provided back to the secure proxy in support of a summary request, the secure proxy may decrypt the user identifier and provide the decrypted user identifier back to the requesting user.

Although the data in data structure 500 is demonstrated for each request, one or more data structures can be used to aggregate information from different API users and API requests. The data structures may maintain information about the frequency that an API user uses the API provider, the frequency that an API request type is used by one or more users, or some other aggregated information.

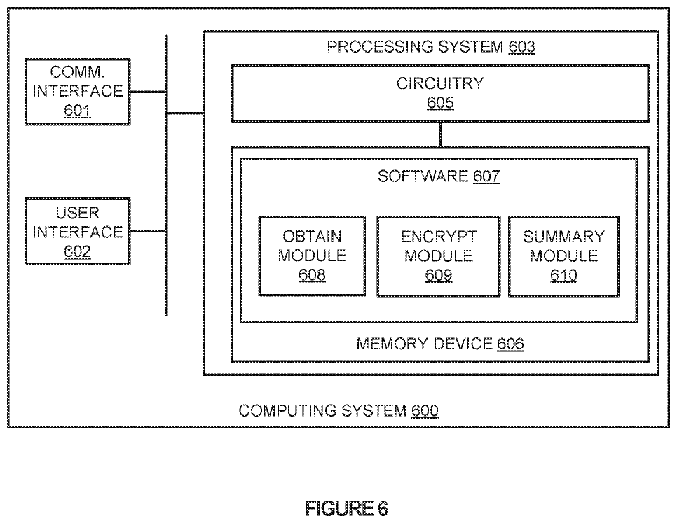

FIG. 6 illustrates a computing system 600 to securely manage API request information according to an implementation. Computing system 600 is representative of any computing system or systems with which the various operational architectures, processes, scenarios, and sequences disclosed herein for a management system may be implemented. Computing system 600 is an example secure proxy 112, although other examples may exist. Computing system 600 comprises communication interface 601, user interface 602, and processing system 603. Processing system 603 is linked to communication interface 601 and user interface 602. Processing system 603 includes processing circuitry 605 and memory device 606 that stores operating software 607. Computing system 600 may include other well-known components such as a battery and enclosure that are not shown for clarity.

Communication interface 601 comprises components that communicate over communication links, such as network cards, ports, radio frequency (RF), processing circuitry and software, or some other communication devices. Communication interface 601 may be configured to communicate over metallic, wireless, or optical links. Communication interface 601 may be configured to use Time Division Multiplex (TDM), Internet Protocol (IP), Ethernet, optical networking, wireless protocols, communication signaling, or some other communication format—including combinations thereof. In at least one implementation, communication interface 601 may be used to communicate with one or more computing systems that act as an API provider that receives API requests from API users. Communication interface 601 may further communicate with one or more console devices that correspond to administrators associated with the API provider. The console devices may comprise smartphones, tablets, computers, or some other console device. Communication interface 601 may further communicate with a monitoring service that stores and maintains encrypted API request information.

User interface 602 comprises components that interact with a user to receive user inputs and to present media and/or information. User interface 602 may include a speaker, microphone, buttons, lights, display screen, touch screen, touch pad, scroll wheel, communication port, or some other user input/output apparatus—including combinations thereof. User interface 602 may be omitted in some examples.

Processing circuitry 605 comprises microprocessor and other circuitry that retrieves and executes operating software 607 from memory device 606. Memory device 606 may include volatile and nonvolatile, removable and non-removable media implemented in any method or technology for storage of information, such as computer readable instructions, data structures, program modules, or other data. Memory device 606 may be implemented as a single storage device but may also be implemented across multiple storage devices or sub-systems. Memory device 606 may comprise additional elements, such as a controller to read operating software 607. Examples of storage media include random access memory, read only memory, magnetic disks, optical disks, and flash memory, as well as any combination or variation thereof, or any other type of storage media. In some implementations, the storage media may be a non-transitory storage media. In some instances, at least a portion of the storage media may be transitory. In no case is the storage media a propagated signal.

Processing circuitry 605 is typically mounted on a circuit board that may also hold memory device 606 and portions of communication interface 601 and user interface 602. Operating software 607 comprises computer programs, firmware, or some other form of machine-readable program instructions. Operating software 607 includes obtain module 608, encrypt module 609, and summary module 610, although any number of software modules may provide a similar operation. Operating software 607 may further include an operating system, utilities, drivers, network interfaces, applications, or some other type of software. When executed by processing circuitry 605, operating software 607 directs processing system 603 to operate computing system 600 as described herein.

In one implementation, obtain module 608 directs processing system 603 to receive API request information from an API provider, wherein the API request information comprises attributes identified for API requests. The API request information may comprise header information, payload information, time stamp information, or some other information associated with API requests to the API provider. As the API request information is obtained, encrypt module 609 directs processing system 603 to encrypt at least a portion of the attributes based on an attribute type associated with each of the attributes and communicate the API request information to an API monitoring service with the portion encrypted. In encrypting the API request information, encrypt module 609 may identify an attribute type associated with each of the attributes and determine whether the attribute type qualifies for encryption. The attribute types may be assigned for encryption by an administrator or may be determined based on whether the attribute is numerical. For example, time stamp information associated with the API requests may not be encrypted to permit processing of the time stamp information. In some implementations, computing system 600 may be located at a first computing site or data center, while the monitoring service computing system may be located at a second computing site or data center. Computing system 600 may be in the same data center as the API provider in some examples.

After providing the encrypted API request information to the monitoring service, summary module 610 directs processing system 603 to receive a summary request associated with usage of the API provider, wherein the summary request indicates at least one attribute in the API request information. For example, a summary request may include a request to indicate API usage associated with an API user. To obtain the required summary information, encrypt module 609 may encrypt a relevant attribute in the query to obtain the data from the monitoring service. In the previous example of requesting API usage associated with an API user, the identifier for the API user may be encrypted to identify the usage data associated with the API user. The encryption of the identifier may be the same as done when storing the API request information. Thus, when the API request information for an API user is stored, the information may be stored with a first encrypted identifier for the user. When a summary request is generated using the identifier for the user, the identifier may be encrypted to identify the first encrypted identifier. The first encrypted identifier can then be used to obtain the required summary information from the monitoring service. Advantageously, the monitoring service may use arbitrary values in monitoring API usage and calculating statistics for the API provider, but an administrator may interact with the API request information using the real identifiers for the data.

In some implementations, as the summary information is provided by the monitoring service, at least a portion of the summary information may be decrypted prior to forwarding the information as a summary to the requesting administrator. For example, a summary request may request API usage as a function of time in relation to one or more API users. When the summary information is obtained, the identifiers for the API users may be encrypted. Accordingly, prior to providing the summary to the user, the encrypted information can be decrypted and forwarded as part of the summary. In some examples, the summary provided by computing system 600 may comprise raw data, wherein the administrative console may generate the display using the raw data. In other examples, the summary information itself from the monitoring service may include a display and software 607 may be used to decrypt any required information in the display to provide to the requesting administrator. In still other implementations, the summary information provided by the API monitoring service may be processed by software 607 to generate the display for the end administrator. The displays may include API usage by API users as a function of time, information about different API function types used by one or more API users, or some other API usage information.

Returning to the elements of FIG. 1, API users 120-122, API provider 110, and monitoring service 130 may each comprise communication interfaces, network interfaces, processing systems, computer systems, microprocessors, storage systems, storage media, or some other processing devices or software systems and can be distributed among multiple devices. Examples of API users 120-122, API provider 110, and monitoring service 130 can include software such as an operating system, logs, databases, utilities, drivers, networking software, and other software stored on a computer-readable medium. API users 120-122, API provider 110, and monitoring service 130 may comprise, in some examples, one or more server computing systems, desktop computing systems, laptop computing systems, or any other computing system, including combinations thereof.

Communication between API users 120-122, API provider 110, and monitoring service 130 may use metal, glass, optical, air, space, or some other material as the transport media. Communication between API users 120-122, API provider 110, and monitoring service 130 may use various communication protocols, such as Time Division Multiplex (TDM), asynchronous transfer mode (ATM), Internet Protocol (IP), Ethernet, synchronous optical networking (SONET), hybrid fiber-coax (HFC), circuit-switched, communication signaling, wireless communications, or some other communication format, including combinations, improvements, or variations thereof. Communication between API users 120-122, API provider 110, and monitoring service 130 may be a direct link or can include intermediate networks, systems, or devices, and can include a logical network link transported over multiple physical links.

The included descriptions and figures depict specific implementations to teach those skilled in the art how to make and use the best option. For teaching inventive principles, some conventional aspects have been simplified or omitted. Those skilled in the art will appreciate variations from these implementations that fall within the scope of the invention. Those skilled in the art will also appreciate that the features described above can be combined in various ways to form multiple implementations. As a result, the invention is not limited to the specific implementations described above, but only by the claims and their equivalents.

What is claimed is:

1. A method comprising:
receiving application programming interface (API) request information from an API provider, wherein the API request information comprises attributes identified for API requests;
encrypting at least a portion of the attributes based on an attribute type associated with each of the attributes;
communicating the API request information to an API monitoring service with the portion encrypted;
receiving a summary request associated with usage of the API provider, wherein the summary request indicates at least one attribute in the API request information;
encrypting the at least one attribute;
retrieving summary information from the API monitoring service based at least on the request with the at least one encrypted attribute; and
generating a summary to support the summary request using the summary information.

2. The method of claim 1, wherein the attributes comprise time stamps, API request type, or sources of requests.

3. The method of claim 1, wherein encrypting at least the portion of the attributes based on an attribute type associated with the attributes comprises:
for each attribute of the attributes, identifying an attribute type;
identifying whether the attribute type qualifies for encryption;
when the attribute type qualifies for encryption, encrypting the attribute;
when the attribute type does not qualify for encryption, abstaining from encrypting the attribute.

4. The method of claim 3, wherein identifying whether the attribute type qualifies for encryption comprises identifying whether the attribute type matches an attribute type selected by an administrator for encryption.

5. The method of claim 3, wherein identifying whether the attribute type qualifies for encryption comprises:
identifying whether the attribute comprises a time stamp; and
identifying that the attribute does not qualify for encryption when the attribute comprises a time stamp.

6. The method of claim 1, wherein receiving the summary request comprises receiving the summary request from an administrator associated with the API provider.

7. The method of claim 1, wherein the summary comprises a visual representation of API request type usage as a function of time.

8. The method of claim 1, wherein the summary comprises a visual representation of user API request usage as a function of time.

9. The method of claim 1, wherein generating the summary to support the summary request using the summary information comprises:
decrypting at least a portion of the summary information; and
generating the summary to support the summary request using the decrypted summary information.

10. A computing apparatus comprising:
a storage system;
a processing system operatively coupled to the storage system; and
program instructions stored on the storage system that, when executed by the processing system, direct the computing apparatus to:
receive application programming interface (API) request information from an API provider, wherein the API request information comprises attributes identified for API requests;
encrypt at least a portion of the attributes based on an attribute type associated with each of the attributes;
communicate the API request information to an API monitoring service with the portion encrypted;
receive a summary request associated with usage of the API provider, wherein the summary request indicates at least one attribute in the API request information;
encrypt the at least one attribute;
retrieve summary information from the API monitoring service based at least on the request with the at least one encrypted attribute; and
generate a summary to support the summary request using the summary information.

11. The computing apparatus of claim 10, wherein the attributes comprise time stamps, API request type, or sources of requests.

12. The computing apparatus of claim 10, wherein encrypting at least the portion of the attributes based on an attribute type associated with the attributes comprises:
for each attribute of the attributes, identifying an attribute type;
identifying whether the attribute type qualifies for encryption;
when the attribute type qualifies for encryption, encrypting the attribute;
when the attribute type does not qualify for encryption, abstaining from encrypting the attribute.

13. The computing apparatus of claim 12, wherein identifying whether the attribute type qualifies for encryption comprises identifying whether the attribute type matches an attribute type selected by an administrator for encryption.

14. The computing apparatus of claim 12, wherein identifying whether the attribute type qualifies for encryption comprises:
identifying whether the attribute comprises a time stamp; and
identifying that the attribute does not qualify for encryption when the attribute comprises a time stamp.

15. The computing apparatus of claim 10, wherein receiving the summary request comprises receiving the summary request from an administrator associated with the API provider.

16. The computing apparatus of claim 10, wherein the summary comprises a visual representation of API request type usage as a function of time.

17. The computing apparatus of claim 10, wherein the summary comprises a visual representation of user API request usage as a function of time.

18. The computing apparatus of claim 10, wherein generating the summary to support the summary request using the summary information comprises:
decrypting at least a portion of the summary information; and
generating the summary to support the summary request using the decrypted summary information.

19. A system comprising:
an application programming interface (API) monitoring service computing system; and
a secure proxy system configured to:
receive API request information from an API provider, wherein the API request information comprises attributes identified for API requests;
encrypt at least a portion of the attributes based on an attribute type associated with each of the attributes;
communicate the API request information to the API monitoring service computing system with the portion encrypted;
receive a summary request associated with usage of the API provider, wherein the summary request indicates at least one attribute in the API request information;
encrypt the at least one attribute;
retrieve summary information from the API monitoring service computing system based at least on the request with the at least one encrypted attribute; and
generate a summary to support the summary request using the summary information.

20. The system of claim 19, wherein encrypting at least the portion of the attributes based on an attribute type associated with the attributes comprises:
for each attribute of the attributes, identifying an attribute type;
identifying whether the attribute type qualifies for encryption;
when the attribute type qualifies for encryption, encrypting the attribute;
when the attribute type does not qualify for encryption, abstaining from encrypting the attribute.
